(19) United States
(12) Patent Application Publication
(10) Pub. No.: US 2023/0364821 A1
(43) Pub. Date: Nov. 16, 2023

(54) Controls, Feedback, Cutting Variations, and Accessories for Chain Saws

(71) Applicant: Chain Orthopedics, LLC, Bogota, NJ (US)

(72) Inventors: Paul VIOLA, Bogota, NJ (US); Timothy J. LANGLOSS, Berwyn, PA (US)

(73) Assignee: Chain Orthopedics, LLC, Bogota, NJ (US)

(21) Appl. No.: 18/315,003

(22) Filed: May 10, 2023

Related U.S. Application Data
(60) Provisional application No. 63/341,032, filed on May 12, 2022.

(51) Int. Cl. B27B 17/08; B27B 17/02

(52) U.S. Cl. CPC B27B 17/083; B27B 17/02

(57) ABSTRACT

Disclosed herein are safety and other controls for chain saws, feedback for use with chain saws, cutting variations in chain saws, and accessories for use with chain saws. In one example, a system comprises a chain saw, a sensor for detecting a condition, and a control system programmed to take an action upon detection of a programmed condition. The chain saw may comprise links with engaging hooks and recesses for articulation without decoupling. The saw bar may comprise a rail, and the links may have grooves such that the links straddle the rail. In one example, a sensor may comprise an image sensor, and a condition detected by the sensor may comprise a position of the chain saw. The control system may be programmed to take action such as to stop or direct movement of the chain saw and/or to produce a perceptible signal.

### CROSS-REFERENCE TO RELATED APPLICATIONS

This application claims priority to U.S. Provisional Patent Application No. 63/341,032, filed May 12, 2022, entitled “Safety Controls, Feedback, Cutting Variations, and Accessories for Chain Saws,” the entire contents of which are incorporated herein by reference.

This application is also related to U.S. Provisional Patent Application No. 63/058,216, filed Jul. 29, 2020, entitled “Thin Single Width Chain Saw,” U.S. Provisional Patent Application No. 63/085,290, filed Sep. 30, 2020, entitled “Thin Single Width Chain Saw,” U.S. Provisional Patent Application No. 63/147,033, filed Feb. 8, 2021, entitled “Chain Saws and Components for Chain Saws,” U.S. Provisional Patent Application No. 63/154,367, filed Feb. 26, 2021, entitled “Cutting Guide Systems,” U.S. Provisional Patent Application No. 63/154,379, filed Feb. 26, 2021, entitled “Systems and Methods for Manufacturing Saws and Saw Components,” U.S. Provisional Patent Application No. 63/195,994, filed Jun. 2, 2021, entitled “Cutting Guide Systems and Methods,” U.S. Provisional Patent Application No. 63/209,525, filed Jun. 11, 2021, entitled “Devices for Maintaining Tension in Chain Saws,” U.S. Provisional Patent Application No. 63/209,540, filed Jun. 11, 2021, entitled “Systems for Robotic Surgery,” U.S. Provisional Patent Application No. 63/305,422, filed Feb. 1, 2022, entitled “Devices for Maintaining Tension in Chain Saws,” U.S. Non-Provisional patent application Ser. No. 17/443,646, filed Jul. 27, 2021, entitled “Chain Saws, Components for Chain Saws, and Systems for Operating Saws,” International Application No. PCT/US2021/043433, filed Jul. 28, 2021, entitled “Chain Saws, Components for Chain Saws, and Systems for Operating Saws,” U.S. Provisional Patent Application No. 63/305,469, filed Feb. 1, 2022, entitled “Knives and Other Tools and Devices Incorporating Cutting Chains,” U.S. Non-Provisional patent application Ser. No. 17/590,192, filed Feb. 1, 2022, entitled “Cutting Guide Systems and Methods,” International Application No. PCT/US2022/014679, filed Feb. 1, 2022, entitled “Cutting Guide Systems and Methods,” U.S. Non-Provisional patent application Ser. No. 17/741,734, filed May 11, 2022, entitled “Devices for Maintaining Tension in Chain Saws,” International Application No. PCT/US2022/028792, filed May 11, 2022, entitled “Devices for Maintaining Tension in Chain Saws,” U.S. Provisional Patent Application No. 63/437,816, filed Jan. 9, 2023, entitled “Systems and Methods for Construction with Detection, Guidance, and/or Feedback,” U.S. Non-Provisional patent application Ser. No. 18/102,910, filed Jan. 30, 2023, entitled “Knives and Other Tools and Devices Incorporating Cutting Chains,” and International Application No. PCT/US2023/011837, filed Jan. 30, 2023, entitled “Knives and Other Tools and Devices Incorporating Cutting Chains.” The entire contents of these applications are incorporated herein by reference.

### TECHNICAL FIELD

The present disclosure is directed to devices, systems, and methods relating to chain saws.

### BACKGROUND

Chain saws have various uses, for example orthopedic applications (cutting of bone or other tissue), construction applications (cutting of wood, drywall, or other construction materials), and other applications.

### SUMMARY

Disclosed herein are various embodiments of safety and other controls for chain saws.

Also disclosed herein are various embodiments of feedback for use with chain saws.

Also disclosed herein are various embodiments of cutting variations in chain saws.

Also disclosed herein are various accessories for use with chain saws.

In one example embodiment, a system for controlling operation of a chain saw comprises a chain saw, a sensor for detecting a condition, and a control system programmed to take an action upon detection by the sensor of a programmed condition.

The chain saw may comprise a saw bar and a plurality of links arranged in a chain along a chain path around the saw bar, wherein a first link comprises a hook on one end that engages a recess of a second link, thereby coupling the first link and the second link and allowing the first link and the second link to articulate with respect to each other without decoupling as the chain is driven around the saw bar. The saw bar may comprise a rail extending along at least part of the chain path around the saw bar, and each of the links in the plurality of links may comprise a groove such that the links straddle the rail of the saw bar, wherein when the links are arranged on the rail, a bottom surface of each lateral side of each link abuts a ledge of the saw bar on either side of the rail such that forces on the links are transferred to the ledges of the saw bar on either side of the rail.

In one example, a sensor may comprise an image sensor, and a condition detected by the sensor may comprise a position of the chain saw. The programmed condition (at which the action is taken) may be a location of a chain saw being a designated distance from a structure desired not to be cut. The action that the control system is programmed to take upon detection of the programmed condition by the sensor may be to stop movement of the chain of the chain saw and/or to produce a signal, such as an audio and/or visual signal.

The sensor may be located on the chain saw. The sensor may be located external to the chain saw. The sensor may be worn by an operator of the chain saw. For example, the sensor may be attached to a glove worn by an operator of the chain saw.

In another example, a chain saw system may comprise a chain saw and one or more subsystems selected from the group consisting of a vacuum subsystem, a cooling subsystem, and an airflow subsystem.

In another example, a method of controlling operation of a chain saw may comprise automatically detecting a condition during operation of a chain saw and taking an action upon the detection of a programmed condition.

Numerous other examples are possible in accordance with the disclosure and within the scope of the appended claims.

### BRIEF DESCRIPTION OF THE DRAWINGS

The accompanying drawings illustrate examples of devices, components, and methods disclosed herein and, together with the description, serve to explain the principles of the present disclosure.

FIG. 1 shows an example embodiment of a chain saw cartridge in accordance with the disclosure.

FIG. 2 shows a single link for a cutting chain of a chain saw such as the cutting chain of the chain saw cartridge in FIG. 1.

FIG. 3A shows an example embodiment of a saw bar that may be used in a chain saw in accordance with the disclosure.

FIG. 3B shows an alternative example embodiment of a saw bar that may be used in a chain saw in accordance with the disclosure.

FIG. 4A shows an enlarged view of the saw bar of FIG. 3A, with a chain of links assembled on the bar, in a partial cut-away view.

FIG. 4B shows an enlarged end view of the saw bar of FIG. 3A at the distal end of the bar, with a single link shown.

FIG. 4C is an enlarged view of a portion of FIG. 4B.

FIG. 5 is a schematic view of an example system for controlling operation of a chain saw.

### DETAILED DESCRIPTION

Specific examples will now be described; however, no limitation of the scope of the claims is intended by these specific examples. Any alterations and further modifications to the described or illustrated systems, devices, components, or methods, and any further application of the principles of the present disclosure, are fully contemplated as would normally occur to one skilled in the art to which the disclosure relates. In particular, the features, components, and/or steps described with respect to one implementation of the disclosure may be combined with features, components, and/or steps described with respect to other implementations of the disclosure. The term “user” refers to one or more persons using the devices, systems, and/or methods described herein, such as one or more surgeons, physicians, operators, or other persons using the devices, systems, and/or methods.

Systems, devices, features, and methods as described herein may be used with chain saws in various applications, such as surgical applications or construction applications. The chain saw may be a type as disclosed in U.S. Pat. No. 9,616,512 and/or U.S. Patent Application Publication No. 2002/0032489 A1, the disclosures of which are hereby incorporated by reference herein in their entirety. For example, a chain saw used in the following example descriptions may comprise: (i) a saw bar having a first longitudinal side, a second longitudinal side, and a distal end, wherein the first longitudinal side, second longitudinal side, and distal end define at least part of a chain path around the saw bar; and (ii) a plurality of links arranged in a chain along the chain path around the saw bar. The saw bar may comprise a rail extending along at least part of the chain path around the saw bar, and each of the links in the plurality of links may comprise a groove such that the links straddle the rail of the saw bar. When the links are arranged on the rail, a bottom surface of each lateral side of each link may abut a ledge of the saw bar on either side of the rail such that forces on the links are transferred to the ledges of the saw bar on either side of the rail. In the chain of links, a first link may comprise a hook on one end that engages a recess of a second link, thereby coupling the first link and the second link and allowing the first link and the second link to articulate with respect to each other without decoupling as the chain is driven around the saw bar. Each link may have a hook on one end for engaging a recess of an adjacent link at that end and a recess on an opposite end for engaging a hook of an adjacent link at that end. The link configurations, including the hooks and corresponding recesses, may be sufficient to keep the links of the chain together without the need for fasteners. Operation of the saw may be controlled manually and/or automatically as described herein.

FIG. 1 shows a first example embodiment of a chain saw cartridge 10 suitable for various applications, such as medical or construction applications. The chain saw cartridge 10 in FIG. 1 comprises a saw bar 20, a plurality of links 40 assembled in a cutting chain around the bar 20, and a drive cog assembly 70.

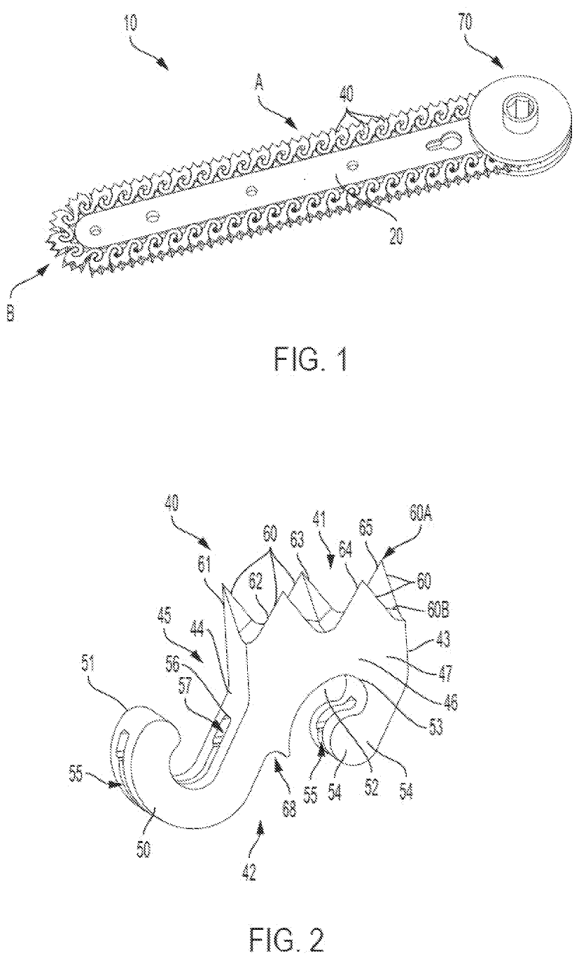

FIG. 2 shows a single link 40 for a cutting chain of a chain saw such as the cutting chain of chain saw cartridge 10 in FIG. 1. The link 40 comprises a top or cutting side 41, a bottom or bar side 42, a first adjacent link side 43, a second adjacent link side 44, a first lateral side 45, and a second lateral side 46.

The link 40 has a hook 50 and a recess 52. The link 40 has a rounded feature or projection 54 that defines one side of the recess 52. In this example embodiment, the hook 50 extends outward from the second adjacent link side 44 and upward from the bottom side 42, and the rounded projection 54 extends downward from the top side 41 and inward from the first adjacent link side 43. The recess 52 extends upward from the bottom side 42 and is shaped to receive a hook 50 of an adjacent link 40.

As shown in FIG. 1, a plurality of links 40 can be connected together in a chain to move along a predetermined path around the bar 20. The recess 52 of one link receives the hook 50 of an adjacent link, whereby the hook 50 fits into the recess 52. The hook 50 of one link thereby interlocks with the rounded projection 54 of an adjacent link. When two adjacent links are in an aligned or non-articulated configuration with one another, such as along a straight part A of the bar 20, the distance between the tip 51 of the hook 50 and the end 53 of the recess 52 leaves a clearance, allowing for articulation. When two adjacent links are in an articulated configuration along a convex path with one another, such as along a convexly curved part B of the bar 20, the articulation causes the hook 50 to engage further into the recess 52, and distance between the tip 51 of the hook 50 and the end 53 of the recess 52 is smaller than along the straight part A. In some embodiments, at the full extent of articulation, i.e., the maximum degree of pivot between adjacent links, the tip 51 of the hook 50 is at its closest point to, and in some embodiments may touch, the end 53 of the recess 52.

The configuration of the links 40 with the hooks 50 and corresponding recesses 52 allows the links 40 to pivot with respect to each other and to remain connected to each other even as they pivot away from each other along a convexly curved path. The links 40 remain connected, avoiding longitudinal disarticulation, without the need for separate connecting elements such as rivets, pins, or other connectors. Thus, the width of the chain is as thin as the width of the cutting links 40, allowing a thin chain, for a thin kerf.

As shown in FIG. 2, the bottom side 42 of the link 40 has a drive cog engagement recess 68. The drive cog engagement recess 68 is for engagement by a drive cog 72. At the top or cutting side 41, the link 40 has a plurality of cutting teeth 60.

The links 40 can have approximately the same width as the saw bar. In such as case, with an arrangement with some cutting teeth having sides flush with a first lateral side 45 of the link 40 and other cutting teeth having sides flush with a second lateral side 46 of the link 40, the lateral side surfaces of the links (including the teeth) and the bar are continuous and relatively smooth. This aids in making bone cuts with a smooth surface.

The cutting width of the links should be equal to or greater than the width of the bar so that the saw does not bind up. For a chain saw to pass through bone the width of the cut made by the chain must be equal to or greater than the width of the bar.

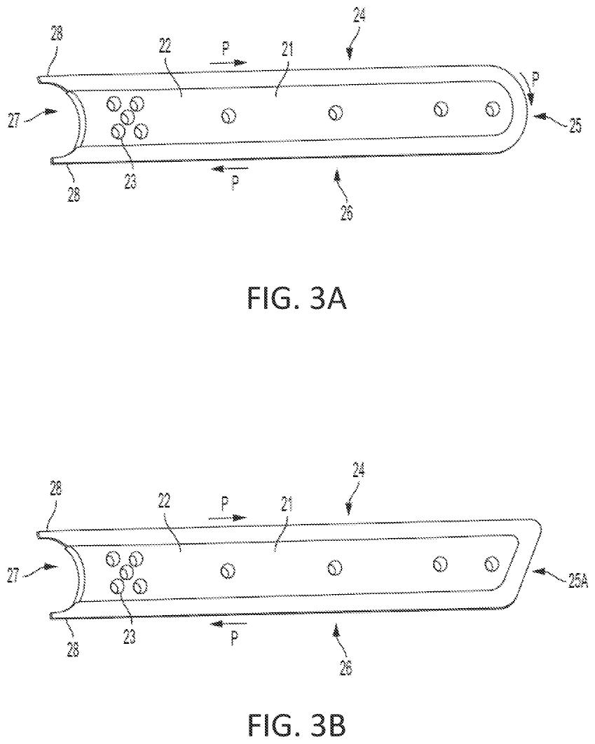

FIG. 3A shows a saw bar 21 that may be used in the chain saw cartridge 10. Saw bar 20 of FIG. 1 and saw bar 21 of FIG. 3A are similar except for having different holes 23 for fixing the bar 21 to the suspension system that attaches to the driving head of the chain saw. The saw bars 20, 21 are generally planar, with a main body 22 that contributes the primary strength and stability of the bar and allows the links to transmit a normal load with respect to the downward pressure of cutting, i.e., a load that is directed normal to the chain path and toward the saw bar. The bar has two sides 24, 26 in the longitudinal direction and a distal end 25 that in the embodiment of FIG. 3A is curved or semicircular. The bar has a recess at the proximal end 27, for accommodating a drive cog. The sides 24, 26 have extensions 28 that facilitate transfer of the continuous link chain from the bar to the drive cog and from the drive cog to the bar. The first longitudinal side 24, the second longitudinal side 26, and the distal end 25 define at least part of a chain path P around the saw bar 21.

The bar 20, 21 could have various other configurations. For example, the distal end 25 can be symmetrical and semicircular as shown in FIG. 3A, or it can have other shapes. In one alternative, as shown in FIG. 3B, the distal end 25A can be asymmetrical, presenting a sloped face with rounded ends that projects more on one side of the saw than the other. The sloped face may be relatively straight and angled with respect to a longitudinal axis of the saw bar such that one longitudinal side of the saw is longer than the other, and the sloped face may have rounded ends where it transitions to the longitudinal sides. Such a distal tip could be desirable in some types of surgery to resist the lateral forces produced by the moving chain approaching a piece of bone straight on.

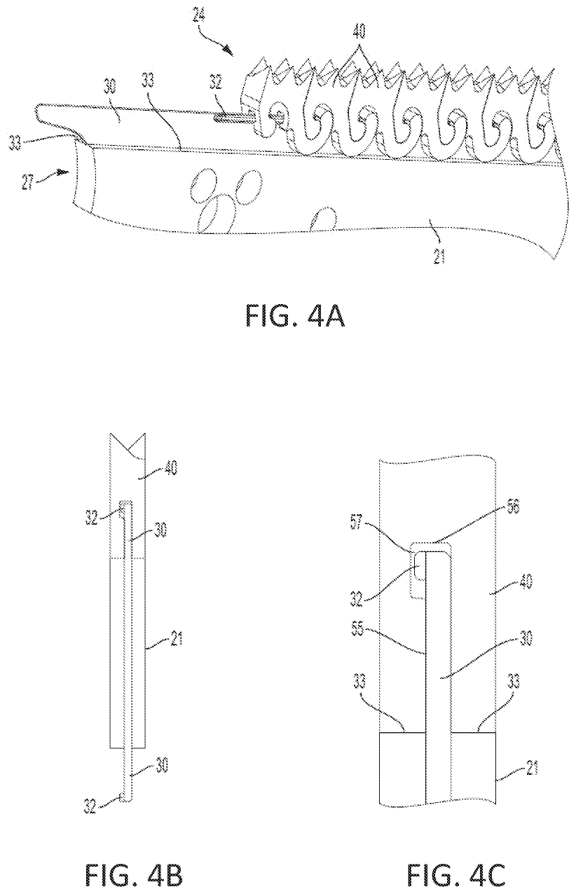

FIG. 4A shows an enlarged view of a first side 24 of the bar 21 at the proximal end 27 of the bar 21, with part of a chain of links 40 assembled on the bar 21, shown in a partial cut-away view. FIG. 4B shows an enlarged end view of the bar 21 at the distal end 25 of the bar 21, with a single link 40 shown for illustration purposes. FIG. 4C is an enlarged view of a portion of FIG. 4B.

As shown in FIGS. 4A, 4B, and 4C, the bar 21 has a rail 30 extending from the main body 22 of the bar 21. The rail 30 extends, in whole or in part, along the sides 24, 26 and the distal end 25 of the bar 21. The rail 30 acts as a monorail along which the links 40 of the chain travel. The rail 30 generally extends in a direction away from the main body 22 of the bar 21. The rail 30 may include a projection 32 that extends laterally beyond one or both sides of the rail 30. The projection 32 acts as a link lock or retention element that prevents the links 40 from coming off of the rail 30 in a direction away from the bar, i.e., in a direction away from the bar generally perpendicular to the direction of travel of the chain.

The links 40 have grooves in them so that the links 40 fit over and straddle the monorail 30. As shown in FIG. 2, the illustrated link 40 has a groove 55 that extends from the bottom side 42 of the link 40 upward part of the way to the top side 41 of the link 40. The top end of the groove 55 is labeled as top end 56. The groove 55 runs parallel to and is located between the first lateral side 45 and the second lateral side 46 of the link 40. The groove 55 extends the longitudinal length of the link 40, from the first adjacent link side 43 through the rounded projection 54 through the link body 47 and the second adjacent link side 44 and through the hook 50. The groove 55 includes a notch 57 that extends laterally beyond one or both sides of the groove 55. The notch 57 is shaped to accommodate the projection 32 of the rail 30.

As shown in FIG. 4C, the groove 55 and notch 57 of a link 40 accommodate the rail 30 and projection 32 of the bar 20, 21 to allow the links 40 to travel around the bar 20, 21 while preventing the links 40 from coming off of the rail 30 in a direction away from the bar 20, 21. In the illustrated example, when the links 40 are assembled on the rail 30, a clearance space is present between the top of the rail 30 and the top end 56 of the groove 55. In addition, in this example, a clearance space is present between the bottom of the notch 57 and the bottom of the projection 32. This allows some small movement or play of the links 40 in a direction away from the bar 20, 21 perpendicular to the direction of travel of the chain around the bar 20, 21. Also, in this example, the width of the groove 55 is slightly wider than the width of the rail 30. This allows some small movement or play of the links 40 in a lateral direction with respect to the bar 20, 21, while the rail 30 and groove 55 prevent any unwanted excessive movement of the links 40 in a lateral direction with respect to the bar 20, 21.

The clearance between the rail 30 and the groove 55 also results in the vertical load from the links 40, i.e., the load in a direction normal to the chain path directed into the saw bar, being taken up by the main body of the saw bar as opposed to the rail 30 itself. Vertical forces from the cutting pyramids of the links 40 are transmitted from the links 40 directly to the skids or ledges 33 of the saw bar on either side of the rail 30. The rail 30 itself is not loaded by these vertical forces. This arrangement tends to press the links 40 into place, while the rail 30 provides resistance to lateral movement or rocking motions of the links.

In other words, the ledges 33 are where the normal downward load from the links is primarily carried. The tangent sections at the bottom of the link 40, i.e., the tangent sections at the bottom of the hook 50 and the projection 54, contact the ledges 33 on either side of the rail 30. Because of the groove 56, the link 40 straddles the rail 30, with one side of the link 40 contacting the ledge 33 on one side of the rail 30 and the other side of the link 40 contacting the ledge 33 on the other side of the rail 30. The separation of the right link side to ledge contact and left link side to ledge contact provides inherent stability and planar control of the link with respect to the bar. The ledges 33 bear the downward forces from the links 40, resulting in stabilizing the links 40 and maintaining the links 40 in the same plane as the plane of the bar. This helps assure that the lateral sides of the links 40 remain substantially coplanar with the sides of the bar 20, 21.

I. Safety and Other Controls

Disclosed herein are various embodiments of safety and other controls for chain saws. Safety controls are useful to reduce the risk of or prevent various potential harms from use of the chain saw. For example, certain embodiments of safety controls disclosed herein reduce the risk of or prevent injury to the operator of the chain saw or another person. In medical applications, safety controls as disclosed herein may be useful to reduce the risk of or prevent injury to the patient, such as tissue or structures that are not desired to be cut. In construction applications, safety controls as disclosed herein may be useful to reduce the risk of or prevent damage to areas that are not desired to be cut, such as electrical wires, gas pipes, water pipes, or other areas where cuts are not desired.

In some example embodiments, one or more sensors are used in the system for detecting a condition, which may be signified by detection of a signal, that can indicate a particular situation. The operation of the chain saw may be controlled in response to the detected condition (e.g., detected signal).

### A. Sensor Locations

In some examples, the sensor(s) may be located on the operator of the saw. For example, the sensor(s) may be on or embedded in gloves worn by the operator. In other examples, the sensor(s) may be worn on the wrist or other area of the operator.

In some examples, the sensor(s) may be located on the saw itself or the system that operates the saw. For example, the sensor(s) may be located on or in the saw bar, such as the tip of the saw bar. In other examples, the sensor(s) may be located in or on the battery or motor operating the chain of the saw.

In some examples, the sensor may be activated by a connection between the operator and the saw mechanism. For example, an operator may wear a lanyard (e.g., around the operator's wrist) that is connected to a switch on the saw. If the operator gets too far from the saw, for example if the saw is mishandled or dropped, the pulling of the lanyard away from the switch activates the switch, in which case the switch senses the disconnected condition. As another example, the saw may include a safety button that the operator must keep depressed while using the saw. If the operator releases the button, the button senses the disconnected condition.

In some examples, the sensor(s) may be located in or on the person or object on which the saw is being used. For example, the sensor(s) may be located in or on tissue of a patient. In other examples, the sensor(s) may be located in or on construction material or objects that are to be cut or not to be cut.

In some examples, the sensor(s) may be located elsewhere. For example, a position sensor may be positioned in an operating room or in a construction area to detect the position of the saw. For example, the sensor(s) may be one or more image sensors, cameras or other devices incorporating image sensors, light sensors, audio sensors, etc., located external to the saw (e.g., in the operating room or construction site) that can detect a condition of the saw, such as the position (location and/or orientation) of the saw, or a condition of a person or other object, such as the position of the operator, material to be cut (e.g., bone locations), and/or material not to be cut (e.g., ligaments). The saw, person, or other object may have one or more sensors or trackers or identifiers or markers on it, such as one or more targets, reflectors, fiducial marks, indicia, etc., to be detected by the external sensor(s) (e.g., image sensor, camera, etc.).

### B. Types of Sensors

The sensor(s) may be used to detect various types of conditions (e.g., the conditions themselves or signals that signify the conditions). Some examples of the types of sensor(s) that may be used include position sensors (including image sensors, e.g., in cameras), proximity sensors, levels, electrical sensors, light sensors, magnetic sensors, radiofrequency sensors, audio sensors, sonic sensors, ultrasound sensors, temperature sensors, on-off sensors, and property sensors. For example, sensors may be used that detect the conductance, capacitance, and/or electrical properties of material being cut or other adjacent material. As another example, sensors may be used that detect other physical properties of material being cut or adjacent material, such as the hardness or softness of the material. For example, sensors may be used to determine what type of tissue is being cut by the saw.

### C. Actions Taken in Response to Sensed Condition

The control system controlling the saw may include automation so that the saw is automatically controlled in a desired manner in response to a particular sensed condition. For example, when a programmed condition is sensed (e.g., a position of the saw at a designated distance from structure not to be cut), the control system may stop the action of the chain saw. This can be done by cutting power to the saw and/or by actively braking the chain. The chain saw may be battery-powered or AC powered, for example. In either case, the control system may cut power to the saw upon sensing of a programmed condition. Other responses to sensing a programmed condition include slowing the chain, reversing the chain, and giving a signal to the operator indicative of the sensed condition. The signal may be, for example, a visual, audio, or radio signal. Other responses to sensing a programmed condition may be to guide the saw in a particular direction (e.g., to control position, angle, and/or depth of cuts) or manner, so as to make a cut at a desired location or in a desired manner.

A control system as implemented herein may comprise or be implemented with computer components including one or more processors, one or more non-transitory computer-readable media, and/or one or more programs. The control of the receipt of input, instructions, and output may be implemented in software, hardware, or a combination of software and hardware.

### D. Example Embodiments

The following are some example embodiments. However, these examples are not limiting. Any of the sensor locations described herein may be combined with any of the types of sensors described herein and with any of the responsive actions described herein.

In one example, the sensor is a temperature sensor. The temperature sensor may be mounted in or on the battery for the saw, the saw motor, or the saw bar, for example. The sensor monitors the temperature of the battery, motor, and/or bar for safety. For example, in response to sensing of an elevated temperature (e.g., overheating), the control system can stop the saw, e.g., by cutting power and/or actively braking. In a related example, the temperature sensor(s) may be used to optimize performance. For example, in response to high temperature, the saw speed may be decreased, and in response to low temperature, the saw speed may be increased.

In another example, a lanyard is worn by the operator, generally tethered to the wrist or any other practical part of the operator or local safety harness, etc. The lanyard is attached to a kill switch whereby if the device (saw) is dropped or knocked out of the operator's hand the motor is stopped. This action may be a passive cutting power off to the drive mechanism or an active braking system. It may also activate a visual, radio, or audio annunciator.

In another example, a sensor in the saw, for example in the tip of the saw bar, senses an electrical signal or field. The electrical signal or field may be that produced by house wiring, high voltage, etc. In response to the signal, the control system activates a signal that informs the operator and/or immediately shuts down the saw from advancing the cutting towards the power source.

In another example with a similar sensor, a device may be used that puts a unique electrical signal (e.g., high-frequency signal) through a system at a construction location, such as through electrical circuits and/or metal piping. The signal facilitates the accuracy and reliability of the device that is monitoring dangerous cutting scenarios.

In another example with a similar sensor, PVC and other nonconductive tubing/pipe devices are filled with a liquid that is conducive to the transmission of signals as if those items were made of metal. Signals are transmitted through the liquid, and the sensor detects the location of the devices. If the system detects that the saw is too close to a particular object, the control system may activate a signal that informs the operator and/or shuts down the saw.

In another example, a light sensor, e.g., in the distal part of the saw bar, monitors the presence and/or intensity of light in the region that it is cutting. To complement this device, a light source is positioned in the area, e.g., behind the patient's knee or near or behind an object being cut. The light sensor gives feedback to the saw control system as to the position of the tip of the bar with respect to the light source and material being cut. This can provide information regarding the remaining material being cut between the bar and the light source and/or information regarding when to stop cutting.

In another example, a magnetic sensor, e.g., in the distal part of the saw bar, monitors the presence and/or intensity of a magnetic field in the region that it is cutting. To complement this device, a magnetic field source is positioned in the area. In response to signals from the sensor, the control system sends signals to the operator and/or controls (e.g., stops) the saw.

In another example, a radiofrequency (RF) sensor, e.g., in the distal part of the saw bar, monitors the presence and/or intensity of an RF signal in the region that it is cutting. To complement this device, an RF source is positioned in the area. In response to signals from the sensor, the control system sends signals to the operator and/or controls (e.g., stops) the saw.

In another example, a sound sensor is used to monitor and evaluate the sound of the different densities or margins of materials being cut. The control system analyzes the audio signal in real time to determine the type of material and to send a signal and/or control the saw depending on whether the material is desired to be cut.

In another example, a sensor is used to monitor and evaluate the conductance, capacitance, or other electrical properties of the materials being cut. The control system analyzes the sensed condition and sends a signal and/or controls the saw depending on whether the material is desired to be cut.

In another example, a sensory system based on ultrasonics and/or sonic range finding is used to accomplish a similar result. The saw system may include an emitter to send the signal that is sensed. The control system analyzes the sensed condition and sends a signal and/or controls the saw depending on sensed signal.

In another example, a sensory system based on temperature is used to supply feedback as to the position of the saw blade with regard to cutting areas characterized by their ambient temperature or change in temperature.

In another example, a sensory system profiles the physical characteristics of different materials to selectively give feedback to the operator and/or computer/robot controlling the saw to change cutting characteristics/profiles or do an emergency shutdown of the powered saw.

In another example, the operator wears trackers, e.g., gloves with trackers, that stop the saw if fingers approach a danger zone or surgical field. The saw may have a kill switch that stops power to the motor (e.g., from the battery) and therefore the rotation of the saw. The system may have software or another control system that activates the kill switch in response to signals from the trackers. For example, the control system may activate the kill switch based on the sensors (trackers) measuring distance to the saw. The sensors may be in gloves, e.g., in the tips of the fingers. In some examples, the sensors may detect other vulnerable materials or structures, such as wires, pipes, and other materials hidden behind wood or drywall. The sensors may also protect anatomical structures such as ligaments, tendons, and vasculature. In some embodiments, the sensors are worn by the operator. In other embodiments, the operator wears a device that can be detected, and the sensor is in a location to detect the device. The kill switch may also be governed by a navigation system either in the medical field or outside the medical field.

In another example, a system with one or more sensor(s) and/or automated responsive action(s) may be incorporated with a mapping system that locates and/or tracks certain features or objects within the operating field of the saw. For example, a system may be used that captures the geospatial locations of certain anatomical features, such as bones and/or ligaments, using a software enabled system. Such locations may be tracked in real time. One or more sensors as described above, such as one or more position sensor(s) on the saw or external to the saw, and/or one or more image sensors or devices with image sensors (e.g., cameras), may detect the position of the saw during its operation. The system correlates the position of the saw to the mapped features, such as a ligament or other structures. If the system detects the saw as being too close to a particular structure (e.g., ligament), the system can automatically stop the saw, slow the saw, or reverse the direction of the saw, or alert the operator with a signal, according to programmed instructions. For example, when the saw approaches the structure (e.g., ligament), the system may automatically shut off the saw so as not to cut the structure. Similarly, by knowing the position of the saw in relation to the mapped features, the control system can control the saw in a desired direction and manner, to make desired cuts (e.g., to make cuts at a desired position, angle, and/or depth).

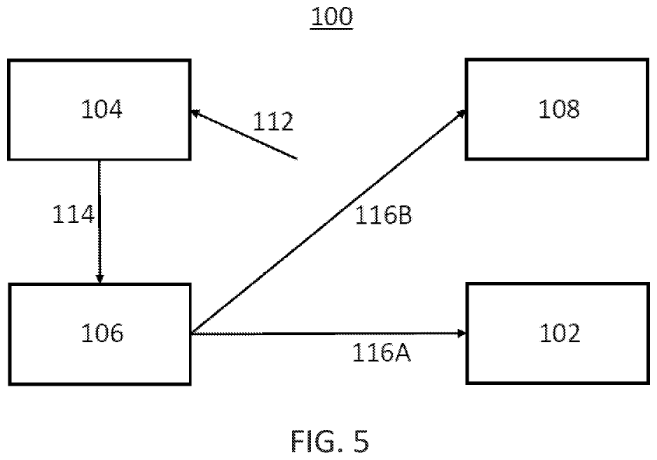

FIG. 5 shows a schematic view of an example system 100 for controlling operation of a chain saw. The system 100 comprises a chain saw 102, a sensor 104 for detecting a condition, and a control system 106 programmed to take an action upon detection by the sensor of a programmed condition. The chain saw 102 may be, for example, a chain saw as described above. The sensor 104 may be a sensor as described above, for detecting a condition as described above.

The programmed condition at which the control system 106 takes the programmed action may be a programmed condition as described above (e.g., a location of a chain saw being a designated distance from a structure desired not to be cut, another location being detected, a designated temperature, a designated softness of tissue detected, an electrical, magnetic, or RF signal detected, a switch being activated, a button being released, etc.). The action that is taken by the control system 106 may be to take an action on the chain saw 102 (e.g., stop movement of the chain, slow the chain, reverse the chain saw, move the chain saw along a desired cutting path, actuate the chain at a desired speed, etc.), as indicated by reference number 116A, and/or may be to produce a signal perceptible by a user 108 (e.g., an audio or visual signal to the operator, such as an alert as to position, temperature, angle of cutting, out-of-plane alignment of the chain saw, etc.), as indicated by reference number 116B.

In use of the example system 100, the sensor 104 detects a condition 112 and sends a signal indicating that condition to the control system 106, as indicated by signal 114. The control system 106 compares that condition to a programmed condition (e.g., a position limit, a temperature limit, activation or release of a switch or button, desired cutting path, etc.). If the programmed condition is met, the control system takes an action, as described above. The action may be an action on the chain saw 102, indicated by 116A, and/or may be the production of a signal perceptible by a user 108, indicated by 116B.

II. Feedback

In some examples, feedback may be used to control the positioning of the saw.

In an example, a visual indicator is mounted that gives feedback to the operator when the saw is held orthogonal to the vertical axis to yield a flat horizontal cut. One example of this is to cut the top of a fence post or the top of footings for an outside porch to facilitate a proper angled mating surface for cross beams or visual appearance of the top of the fence posts.

In another example, the handheld saw, or the bar of the handheld saw, has a laser sensor that gives feedback to the user and/or system (e.g., the system positioning the chain saw) to guide it via a laser which is located at a distance from the operator. This laser may be set to a level orientation or at a specific angle. This angle may be set up in the Y plane as well as the X plane. A surveying device (e.g., Leica master station) along with a laser-mounted sensor on the handheld saw (and/or robotically-controlled and/or mechanically-controlled saw) facilitates complex and accurate cuts to be made in the field and/or at construction sites with very little setup.

III. Cutting Variations

In some examples, the configuration of the links and/or cutting teeth of the chain saw may be varied for different applications. The variations may be tailored for the forming and/or abrasion/resurfacing of various materials.

In some examples, the saw may be made of a material that inherently does not produce sparks and may be used in explosive environments such as gas refineries, etc.

In some examples, the cutting region of the chain saw links may be shaped as a scoop (e.g., shaped like an ice cream scooper) to be used to remove materials such as cartilage vertebral discs. A saw with such links may also be used as a trenching tool for such applications as putting in sprinkler systems for lawns. The edge of the scoop may be rounded, blunted, a sharp edge at varying degrees of angles, or of a configuration such as having serrations tailored to the desired application. For construction, this may be used to remove old silicone sealant, caulking, etc.

In some examples, the cutting region of the chain saw links may have a shape that is conducive to induction heating where the tip of the link may be heated to a temperature that facilitates the melting and removal of materials, e.g., plastics.

In some examples, the cutting region of the chain saw links may have a shape that is conducive to cooling (e.g., via liquid nitrogen, dry ice, evaporative cooling). This may be used to quench substances that generally are not effectively abraded, sheared, or sliced at ambient temperatures (e.g., polylactic acid).

IV. Accessories for Chain Saws

In accordance with the disclosure, various accessories may be used with chain saws.

In some examples, a video camera, still camera, illumination, and/or strobe illumination may be used. Such a system may be used to make the links look as if they are not moving at all. Feedback from the links to a triggering mechanism for the strobe may be used to synchronize the strobe to the position of the links. Such a system may be used to enable the operator to see certain issues that may arise, such as splintering or a broken cutting tooth.

In some examples, the system, in addition to the chain saw, may include a vacuum subsystem adapted to clear away debris from a cutting action of the chain saw, an air chilling/quenching (cooling) subsystem adapted to lower a temperature of the chain saw, and/or an airflow subsystem to disperse particles blocking an operator's view of the work product (i.e., to blow away debris from a cutting action of the chain saw).

In some examples, cutting fluids (e.g., water and/or water-based or oil-based fluids, etc.) may be used to increase cutting speeds, efficiency, blade life, surface finish, cooling, dust suppression, etc.

In some examples, the system may include use of a vacuum, fluid, and/or airborne particle system to recover cutting fluids as well as particles being released into the air/environment. This recovery decreases cleanup, improves general working conditions, and reduces exposure of undesirable particles to the environment as well to the operator. For example, this is useful with harmful materials, such as in the machining of beryllium copper, which can be poisonous when ground or machined, or in cutting pipes encased in asbestos.

In some examples, the system includes handles, guards, and/or guides. For example, a guide shaped as a horseshoe guard may be used over the end of the saw bar.

What is claimed is:

1. A system for controlling operation of a chain saw comprising:
a chain saw;
a sensor for detecting a condition; and
a control system programmed to take an action upon detection by the sensor of a programmed condition.

2. The system for controlling operation of a chain saw as in claim 1, wherein the chain saw comprises: (i) a saw bar having a first longitudinal side, a second longitudinal side, and a distal end, wherein the first longitudinal side, second longitudinal side, and distal end define at least part of a chain path around the saw bar; and (ii) a plurality of links arranged in a chain along the chain path around the saw bar, wherein a first link comprises a hook on one end that engages a recess of a second link, thereby coupling the first link and the second link and allowing the first link and the second link to articulate with respect to each other without decoupling as the chain is driven around the saw bar.

3. The system for controlling operation of a chain saw as in claim 2, wherein the saw bar comprises a rail extending along at least part of the chain path around the saw bar, and each of the links in the plurality of links comprises a groove such that the links straddle the rail of the saw bar, wherein when the links are arranged on the rail, a bottom surface of each lateral side of each link abuts a ledge of the saw bar on either side of the rail such that forces on the links are transferred to the ledges of the saw bar on either side of the rail.

4. The system for controlling operation of a chain saw as in claim 1, wherein the sensor comprises an image sensor.

5. The system for controlling operation of a chain saw as in claim 1, wherein the condition detected by the sensor comprises a position of the chain saw.

6. The system for controlling operation of a chain saw as in claim 1, wherein the programmed condition is a location of a chain saw being a designated distance from a structure desired not to be cut.

7. The system for controlling operation of a chain saw as in claim 1, wherein the action that the control system is programmed to take upon detection of the programmed condition by the sensor is to stop movement of the chain of the chain saw.

8. The system for controlling operation of a chain saw as in claim 1, wherein the action that the control system is programmed to take upon detection of the programmed condition by the sensor is to move the saw in a desired direction.

9. The system for controlling operation of a chain saw as in claim 1, wherein the action that the control system is programmed to take upon detection of the programmed condition by the sensor is to produce a signal.

10. The system for controlling operation of a chain saw as in claim 9, wherein the signal is a visual or audio signal.

11. The system for controlling operation of a chain saw as in claim 1, wherein the sensor is located on the chain saw.

12. The system for controlling operation of a chain saw as in claim 1, wherein the sensor is located external to the chain saw.

13. The system for controlling operation of a chain saw as in claim 1, wherein the sensor is worn by an operator of the chain saw.

14. The system for controlling operation of a chain saw as in claim 1, wherein the sensor is attached to a glove worn by an operator of the chain saw.

15. A chain saw system comprising:
a chain saw comprising: (i) a saw bar having a first longitudinal side, a second longitudinal side, and a distal end, wherein the first longitudinal side, second longitudinal side, and distal end define at least part of a chain path around the saw bar; and (ii) a plurality of links arranged in a chain along the chain path around the saw bar; and
one or more subsystems selected from the group consisting of a vacuum subsystem, a cooling subsystem, and an airflow subsystem.

16. The chain saw system as in claim 15, wherein the subsystem comprises a vacuum subsystem adapted to clear away debris from a cutting action of the chain saw.

17. The chain saw system as in claim 15, wherein the subsystem comprises a cooling subsystem adapted to lower a temperature of the chain saw.

18. The chain saw system as in claim 15, wherein the subsystem comprises an airflow subsystem adapted to blow away debris from a cutting action of the chain saw.

19. A method of controlling operation of a chain saw comprising:
automatically detecting a condition during operation of a chain saw; and
taking an action upon the detection of a programmed condition.

20. The method of controlling operation of a chain saw as in claim 19, wherein the chain saw comprises: (i) a saw bar having a first longitudinal side, a second longitudinal side, and a distal end, wherein the first longitudinal side, second longitudinal side, and distal end define at least part of a chain path around the saw bar; and (ii) a plurality of links arranged in a chain along the chain path around the saw bar, wherein a first link comprises a hook on one end that engages a recess of a second link, thereby coupling the first link and the second link and allowing the first link and the second link to articulate with respect to each other without decoupling as the chain is driven around the saw bar.
